(19) United States
(12) Patent Application Publication
(10) Pub. No.: US 2007/0139724 A1
(43) Pub. Date: Jun. 21, 2007

(54) Paper UI method including local printing

(75) Inventor: Robert Hutter, Brighton, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/313,405

(22) Filed: Dec. 20, 2005

(51) Int. Cl. H04N 1/38

(52) U.S. Cl. 358/464; 358/474

(57) ABSTRACT

A machine readable instruction sheet for scanning along with a document. The machine readable instruction sheet has machine readable markings including instructions for multiple tasks, wherein at least one of the multiple tasks includes printing a copy of the document locally. A user scans the document along with a machine-readable instruction sheet exactly one time, the device scans the machine readable area and prints a copy of the document and electronically transmits a copy of the document to a recipient.

The embodiments disclosed herein are directed to document scanning and more specifically to a method for producing multiple outputs of a scanned document.

The widespread availability of optical scanners, facsimile (fax) machines, multifunction devices, and other devices and subsystems by which computers and computer networks can “read” paper documents has given rise to the concept of a paper-based user interface. A paper-based user interface allows the user of a computer, computer network, or other digital information processing system to communicate with the system simply by making a mark or marks on a paper document or documents and then scanning the document thus marked into the system via a scanner, fax machine, multifunction device, or the like.

A paper-based user interface can serve as a complement or substitute for the more conventional keyboard-mouse-display type of user interface mentioned earlier. A paper-based user interface is particularly appealing when the user interacts with a computer network directly through a multifunction device, without recourse to a personal computer or workstation. In this situation, the user can initiate a number of functions, such as document copying, facsimile, electronic mail, document storage, and search using a simple paper form as an interface. The multifunction device “reads” what is on the form and responds accordingly, possibly with help from the network.

Paper-based user interfaces typically require that forms be created in advance, either by the user with a form editor or automatically by computer, so that the receiving computer can readily determine whether and where a given form has been marked by a user. For example, specially coded information, such as a pattern of data glyphs or a bar code, can be included in the form itself to indicate the instructions to the device. The device (or a computer networked to the device) can be programmed in this case to seek the coded information at a predesignated location within the received image, and to use the coded information together with additional (stored or preprogrammed) information to determine what is to be done.

In particular, exemplary paper-based user interfaces are known that allow a user to designate what happens to a scanned version of a hard copy document. FlowPort™ is one such system. The user accesses a website where the user creates a cover sheet for the scan job. The cover sheet includes markings called glyphs that contain instructions regarding the document to be scanned. These instructions can include, but are not limited to, what format the scanned document will take and to where or who the document will be sent. For example, when a FlowPort™ user scans a document using a “Scan to Myself” cover sheet, the document is scanned to the user's e-mail address.

Currently, paper UI's do not include machine-readable instructions for local printing. Local printing is defined as printing by the device which scans the machine readable instruction sheet and document. The machine readable instruction sheet will is typically used as a cover sheet. This way the scanning device reads the instructions thereon first. Machine readable cover sheets were created for the purposes of manipulating electronic copies of the document, usually through a network. The absence of local printing capabilities is logical in that if the user wants a hard-copy of the document, they do not need to go through the trouble of using a paper UI, but instead can simply scan the document and select the “Print” button on most copiers. However, sometimes a user may both want to print a copy of the document and scan it to an email address. The situation where the user wants both an electronic copy and a printed copy has not previously been addressed.

Presently, producing a physical copy and electronically sending a copy of the document to an electronic location such as an email address are completed by separate user operations. The user scans the document to, for example, an email address using a machine readable instruction sheet and then scans the document again without the machine readable instruction sheet to produce a hard-copy, or vice-versa. It would be useful to be able to generate a machine readable instruction sheet that could be used to print a copy locally at the same time a copy of the document was electronically transmitted elsewhere.

Embodiments include a machine readable instruction sheet that includes machine readable markings for accomplishing multiple tasks including printing locally. For example, the machine readable instruction sheet may be marked with a coded set of instructions to both print the document and send an electronic copy to an email address. A copying device would accomplish both tasks with only one “run” of the original through the document handler.

Various exemplary embodiments will be described in detail, with reference to the following figures.

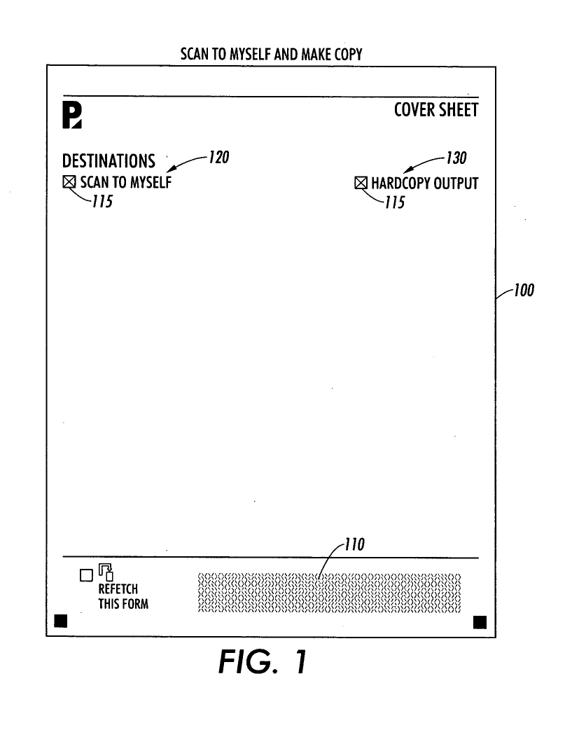

FIG. 1 shows a first exemplary embodiment of a machine readable instruction sheet.

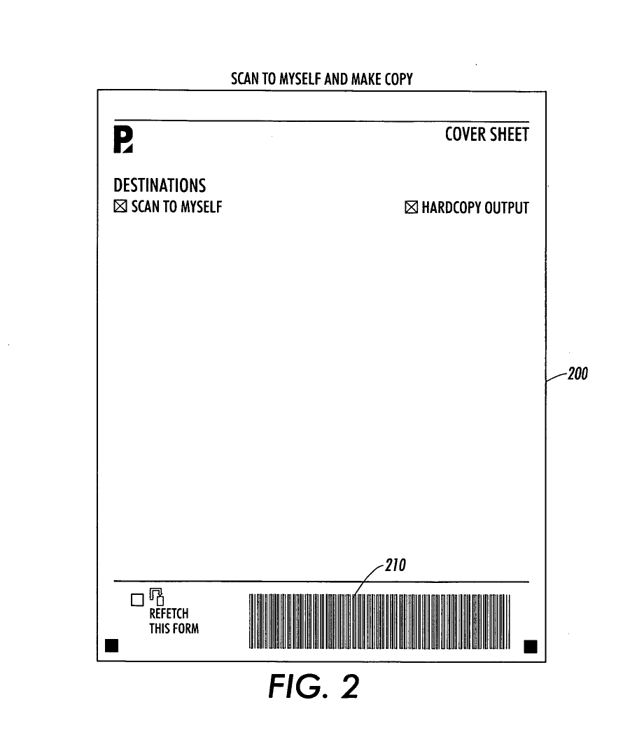

FIG. 2 shows a second exemplary embodiment of a machine readable instruction sheet.

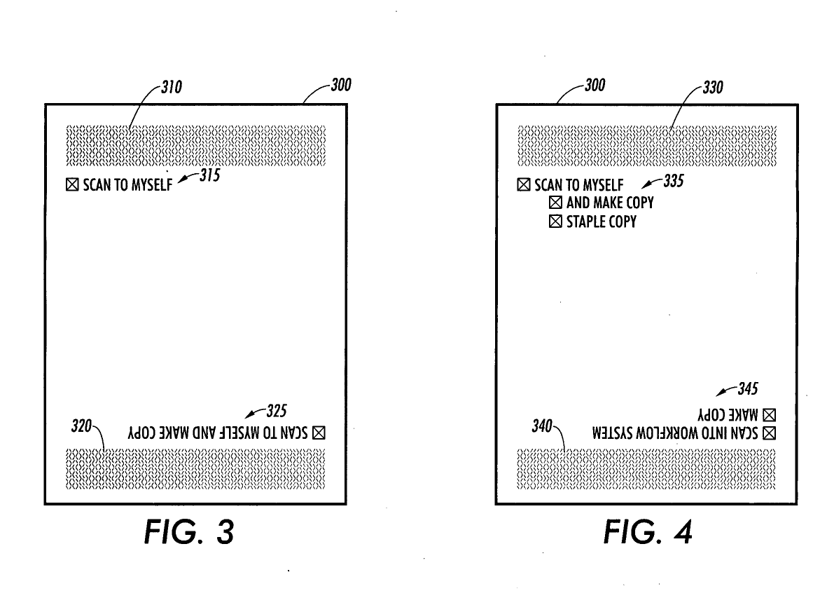

FIG. 3 shows a third exemplary embodiment of a machine readable instruction sheet.

FIG. 4 shows a fourth exemplary embodiment of a machine readable instruction sheet.

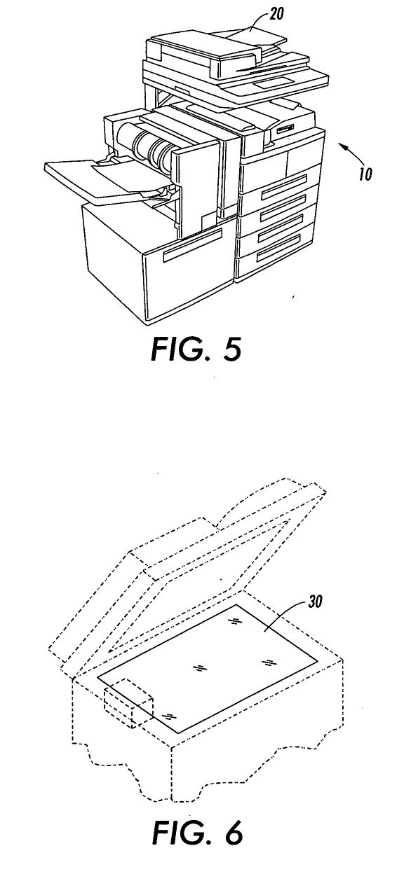

FIG. 5 is a schematic illustration of an exemplary printing device with scanner input.

FIG. 6 is an exemplary, schematic illustration of a scanner attached to a printing device.

A printing device as used herein refers to any device that produces visible marks on paper. Printing devices include, for example, copiers, printers, or multi-function devices. Paper as used herein refers to any markable media such as, for example, paper, plastic, and textile materials.

A copying device is any device capable of scanning and locally producing a copy of a document, regardless of whatever other features the device may have.

A multi-function device or multi-function scanning device is any device that includes a scanner and a plurality of output options (e.g., copying, printing, electronic transmission).

A document as referred to herein includes one or more pages of printed paper or pages to be printed.

FIG. 5 is a schematic illustration of a multi-function device 10 with a document handler 20 into which documents to be copied are inserted to be fed to a scanning device. The device 10 can produce local copies of a scanned document among other functions. FIG. 6 shows a schematic image of a platen 30 of a scanner that would be part of the device 10. To produce copies, documents are placed on platen 30 and scanned. The front of platen 30 is the portion that is closest to the user making a copy. The rear of the platen 30 is the portion of the platen farthest from the user. The document handler 20 would feed sheets to the platen where they would be scanned.

FIG. 1 illustrates an exemplary embodiment of a machine readable instruction sheet 100 for a paper-based UI system. A user would place the machine readable instruction sheet 100 on top of a document and then place both it and the document into the document handler 20. When the device 10 scans in the document along with machine readable instruction sheet 100, the device, or a computer operably connected to the device either directly or through the network, reads the information present on the face of machine readable instruction sheet 100 and processes the document according to that information. The information is usually embedded within machine readable information 110 printed on the face of the machine readable instruction sheet 100. That information may contain the computer instructions themselves or it may contain an electronic address and a form identification code where the scanned data is sent to the address and the information thereon is interpreted depending on which form code was embedded. There are, of course, other systems possible.

In the illustrated embodiment, the machine readable information 110 is in the form of glyphs. In this case, the form 100 uses the glyphs 110 to convey instructions to the multifunction device 10 or to an attached computer regarding the document. While glyphs are shown, other machine readable means of conveying information, such as bar codes, may be used as well. FIG. 2 illustrates a paper UI cover sheet 200 having machine readable information in the form of a bar code 210.

Machine readable instruction sheets 100 are used to instruct the device scanning the sheet on what tasks to perform upon scanning the accompanying document. For example, the machine readable instruction sheet 100 may instruct the device to send a copy to the user's email address, multiple email addresses, or a database. Machine readable instruction sheet 100 includes a machine-readable portion 110. FIG. 2 also illustrates an alternative machine-readable sheet 200 with a machine-readable area 210. The machine-readable areas 110, 210 can also include instructions to print a copy of a document locally in addition to other instructions.

The form 100 can include a number of different user selectable features. Shown in FIG. 1 are “SCAN TO MYSELF” 120 and “HARDCOPY OUTPUT” 130. In embodiments, next to each user selectable feature is an empty box 115 that the user may select. The boxes 115 could be manually checked or automatically checked by the device when the form was originally generated. For example, users may generate paper UI coversheets at a remote location on a PC or other device where the user would select desired features before printing the form. However, a series of generic forms such as the form 100 may be generated with a list of common selections the user may make. When the sheets are generated, the instructions for what to do with an associated document are generally contained in the machine-readable portion 110.

In embodiments, the descriptions and check boxes merely inform the user what instructions are present on a particular sheet 100. In other embodiments, these checkboxes 115 could also be read by the printing device to determine what to do with a scanned document. In other words, the machine readable instructions could include the checked boxes. Conceivably the machine readable instruction sheet 100 could contain an array of every possible desired combination of outputs and the user would simply select which outputs s/he wants by checking the adjacent checkbox.

The user selectable features shown on sheet 100 are nonexhaustive and a variety of others could be easily and immediately contemplated. The machine readable information sheet 100 could include other features such as, for example, a listing of potential email recipients, a plurality of subject lines for any email sent, a plurality of databases into which the data may be stored, a plurality of remote networked printers to which the document may be sent, or an internet fax address to which the document may be sent.

FIGS. 3 and 4 illustrate the front and back of a multi-function document cover sheet 300. Sheet 300 includes four marked areas 310, 320, 330, and 340. Each area includes instructions for “actions” or sets of actions (for example, copying, scanning, entering into a workflow, finishing the copy, or any combination of these).

In embodiments, the marked areas 310, 320, 330, and 340, are located at the front-top, front-bottom, back-top, and back-bottom of sheet 300 respectively. This arrangement provides a relatively simple way to limit the printing device to following one set of instructions.

For example, when using the cover sheet 300 with a digital copier 10, the user takes his hard-copy original and places the cover sheet 300 on top of the first page of the original. To select one of the four possible actions, the user would place the cover sheet so the desired action is face up and right-side up on the top of the originals. The user would then place the document and cover sheet 300 into the document handler 20. Then the user pushes a “start” button on the copier, preferably without having to specify to the UI whether he is doing a scanning or copying job the machine should be able to figure that out from reading the cover sheet.

When the digital copier runs the cover sheet and the originals through the document handler 20, the copier 10 looks at and “obeys” only the instruction set (embedded in machine-readable code) that is at the top of the front side of the cover sheet; the other three instruction sets are ignored. To change which instruction set the device 10 follows, the user merely rotates the cover sheet 300 180° or flips the cover sheet 300 over. For different desired actions at different times, the user just places the same cover sheet over the originals at different orientations: whatever instruction set is “right-side-up” relative to the original, is the instruction set that will be carried out. Alternatively, the device could be programmed to only read a machine readable area in a particular location upon scanning, or it could be programmed to follow only the instructions in the first machine readable area it scans. If either the latter methods are used, the instruction sets do not necessarily have to be oriented 180° apart. Similarly, instructions could be encoded into each machine-readable area that order the device not to read any other areas. The orientation of the cover sheet could still determine which instruction set to file.

In addition to the glyphs or other machine-readable code containing each set of instructions, sheet 300 may include text identifying which actions are encoded into each marked area. For example, area 310 includes “Scan to myself” 315, area 320 includes “Scan to myself and make a copy” 325, area 330 includes “Scan to myself, make a copy, and staple the copy” 335, and area 340 includes “Scan into a workflow system and make a copy” 345.

In the embodiment shown in FIGS. 3 and 4, each machine readable area is placed in one of four positions. Two positions are located on each side, with one machine readable area on each side printed upside down from the bottom edge on the single sheet. The particular configuration shown in FIGS. 3 and 4 has a symmetry that can be exploited for selection purposes. However, other arrangements could be used. While sheet 300 has four marked areas 310, 320, 330, and 340, the sheet could contain fewer or more marked areas with instructions. There could simply be two on one side as shown in FIG. 3 or three with one of the machine-readable areas on the second side. More areas could be added as well. Instructions could be written along all four edges of a sheet of paper and the instructions followed would depend upon how the paper was fed into the printing device. If more sets of instructions are added, a method for selecting which set of instructions the scanning device follows would need to be created.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

1. A machine readable instruction sheet for scanning along with a document, the machine readable instruction sheet comprising machine readable markings,
wherein the machine-readable markings include instructions for multiple tasks, and
wherein at least one of the multiple tasks includes printing a copy of the document locally.

2. The sheet of claim 1, wherein at least one other of the multiple tasks includes sending an electronic copy to a recipient.

3. The sheet of claim 1, further comprising at least one user-selectable parameter on its face.

4. The sheet of claim 2, the at least one user-selectable parameter includes a check box on the sheet.

5. The sheet of claim 2, further comprising a written description of the at least one user-selectable parameter.

6. The method of claim 1, further comprising a written description of the instructions included in the machine readable markings.

7. The sheet of claim 1, wherein the machine readable markings include a bar code.

8. The sheet of claim 1, wherein the machine readable markings include glyphs.

9. A printing device method comprising:
scanning exactly one time a document along with a machine-readable instruction sheet,
printing a copy of the document based upon content of the machine readable. instruction sheet, and
electronically transmitting a copy of the document to a recipient based upon content of the machine readable instruction sheet.

10. The method of claim 9, further comprising receiving the document and machine readable sheet from the recipient of the electronically transmitted copy.
